(19) United States
(12) Patent Application Publication
(10) Pub. No.: US 2024/0242600 A1
(43) Pub. Date: Jul. 18, 2024

(54) Infrastructure Sensor Processing

(71) Applicant: Alchera Data Technologies Ltd, Cambridge (GB)

(72) Inventors: Joned SARWAR, Cambridge (GB); Emil HEWAGE, Cambridge (GB); Anna JORDAN, Cambridge (GB); Daga PANKAJ, Cambridge (GB); Jay SANTOKHI, Cambridge (GB); Aaron CROUCHER, Cambridge (GB)

(21) Appl. No.: 18/559,452

(22) PCT Filed: May 4, 2022
(86) PCT No.: PCT/GB2022/051123

§ 371 Date: Nov. 7, 2023

(30) Foreign Application Priority Data
May 7, 2021 (GB) 2106564.4
Jan. 13, 2022 (GB) 2200399.0

(51) Int. Cl. G08G 1/01

(52) U.S. Cl. CPC G08G 1/0145; G08G 1/0112; G08G 1/0129

(57) ABSTRACT

A computer-implemented method for determining data indicative of a state of a network. The method comprises determining a future time step based upon a current time step and a prediction time period, receiving first real-time data associated with the network, inputting the first real-time data to a predictive network model trained to generate predicted real-time data, to generate predicted real-time data for the future time step, executing a first network model based upon the predicted real-time data for the future time step to generate network model output data.

### FIELD

The present application is directed to systems and methods for determining data indicative of a state of a network such as a traffic network.

### BACKGROUND

Networks such as computer networks and transportation networks may be provided with sensors that enable real-time monitoring of the state of the network. Network operators may use such real-time data to determine whether adverse events are occurring in the network in real-time and to take appropriate action.

There may also exist models of networks that may simulate the operation of the network, such as traffic flow simulations. Such models however are typically complex and have a long processing time such that these models cannot be used in real-time monitoring and decision making. Typically these types of models are used in infrastructure planning and provides longer term forecasts for planning decisions. However, these models may provide insightful data regarding how the state of the network may evolve. As such, it is desirable to incorporate such models into real-time network monitoring systems.

### SUMMARY

There is described herein a computer-implemented method for determining data indicative of a state of a network. The method comprises, receiving first real-time data associated with the network; determining a future time step based upon the current time step and a prediction time period; inputting the first real-time data to a predictive network model trained to generate predicted real-time data, to output predicted real-time data for the future time step; executing a first network model based upon the predicted real-time data for the future time step to generate network model output data. The network model output data may provide the data indicative of the state of the network. Additionally or alternatively, the method may also comprise, at the future time step: receiving second real-time data associated with the network; and determining data indicative of the state of the network based upon the second received real-time data and the network model output data.

In this way, the method is able to provide accurate and timely data indicative of the state of the network substantially more quickly than would be possible simply by executing the first network model based on the real-time data for the current time step. That is, the method may allow generation of data indicative of the state of the network in substantially real-time. In particular, by providing, at a time step prior to the particular time step, real-time data to a predictive network model, the predictive network model is able to predict the data that will be received at the particular time step. By providing the output of the predictive network model (i.e. the prediction of the real-time data for the particular time step) to the first network model, the model output provides a prediction of the state of the network at the particular time step.

There is also described herein a computer-implemented method for determining data indicative of a state of a network. The method comprises, receiving first real-time data associated with the network. The first real-time data may be associated with a first set of components or locations within the network. The method may comprise inputting the first real-time data to a predictive network model trained to generate predicted real-time data relating a second set of components or locations within the network, wherein at least one or more of the second set of components or locations is not present in the first set. The method comprises executing a first network model based upon the predicted real-time data to generate network model output data.

In this way, the method is able to generate data indicative of a state of the network for locations or components that are not present in the first received data set. For example, one or more of the second set may be components or locations for which it is not possible to obtain sensor data. One or more of the second set may be components or locations for which data is not available in real-time or is available at a lower frequency.

The methods may be used together or separately. That is, a method may include using a predictive network model to generate predicted real-time data relating to components or locations that are not present in the first real-time data and may additionally include using a (or the) predictive network model to generate predicted real-time data for a future time step. The predicted real-time data for the future time step may include predicted real-time data for the components and/or locations that are not present in the first set of real-time data.

Receiving real-time data (e.g. the first and second real time data) may comprise receiving data from one or more physical components of the network. The components may take be any component that is configured to report information concerning an entity within the network. The entity within the network may be the component itself and/or another component within the network. The information may, for example, indicate a behaviour, state, property, parameter, etc, of the entity within the network. The components may be sensors of any type. By way of example only, the components may be image sensors (including, for example, cameras, light sensors, CCDs etc), GPS sensors, radar sensors, lidar sensors, acoustic sensors.

It will be appreciated that the network may be any type of network comprising a plurality of components. While real-time data about each of the components is received as part of the method, the components of the network need not be in data communication directly with one another, but may instead be networked in other ways, such as through physical connections in a road network. To aid illustration, a number of examples are provided below, although it is to be understood that the networks may be other than provided in these examples.

For example, the network may be a transport network. In this case, the components may be traffic sensors (such as, by way of example only, speed cameras, video vehicle detection systems, pneumatic road tube counting systems, piezoelectric sensor systems, inductive loop sensor systems, magnetic sensors, acoustic detectors, passive infrared sensors, doppler microwave sensors, radar sensors, lidar sensors, etc.). The components may comprise fixed sensor systems or sensors aboard vehicles within the transport network (e.g. vehicle telematics and on-board traffic sensors). The transport network may include any one or more of road networks, rail networks, waterways, flight channels, etc.

The network may be a communications network, such as a network of computers. The components in this case may be computers within the network. One or more of the computers may be configured to report real-time data relating to itself, or other computers within the network.

The network may be a network of infrastructure within a geographical area or municipality. For example, the network may be what may be referred to as a “smart city”. The network may include buildings, transport infrastructure (such as roads, rail, pedestrian walkways) and assets (such as vehicles), and people.

Determining a prediction time period may comprise determining a processing time of a first network model. The prediction time period may be equal to, or based upon, the time taken for the first network model to generate model output data. By way of example only, the first network model may take of the order of thirty minutes to generate a model output based upon the real-time data and the prediction time period may be equal to thirty minutes or based upon thirty minutes. For example, the prediction time period may be a function of the processing time of the first network model. The prediction time may also take account of one or more other operations such as validation of real-time data received at the future time step. Determining a processing time of the first network model may comprise receiving a processing time of the first network model. For example, the first network model may have a default processing time. Alternatively, determining a first processing time of the first network model may comprise performing one or more executions of the first network model on representative data to determine a processing time of the first network model. In this regard, the processing time may be an expected processing time.

The first network model may be a model that has greater complexity than the predictive model and is unable to operate in real-time. By providing a prediction of the real-time data for a future time step as input to the first network model, the first network model can be perceived as operating in real-time and real-time decisions can be made that includes the additional modelling capability of the first network model. In addition, the first network model may be a legacy model that cannot be easily re-trained or adapted to new data sources. The predictive model can process data sources that the first network model cannot and generate input data for the first network model that has taken these additional data sources into account.

The method may comprise maintaining an historical accuracy model. The historical accuracy model may enable accuracy to be determined as a function of, e.g. input accuracy, time of day and/or location without needing to explicitly calculate accuracy of the first network model. The historical accuracy model may process the output of the first network model and determining the data indicative of the state of the network may be based upon the output of such processing.

Determining a prediction time period may comprise selecting/specifying a prediction time period based upon a prediction requirement. By way of example only, where an application requires an understanding of the state of the network fifteen minutes in advance, and where the first network model takes fifteen minutes to generate a model output, the prediction time period may be thirty minutes.

Receiving the first real-time data and generating predicted real-time data for the future time step may take place at the current time step. The determination of a future time step may take place during the current time step or may take place in a previous time step. For example, the prediction time period may be fixed such that it may be determined in a previous time step. Alternatively, the prediction time period may be adaptively determined at each time step based upon any applicable criteria. For example, the prediction time period may be determined based upon performance of the first network model in one or more previous time steps, the received real-time data (e.g. quality, quantity, etc.) or changing application requirements. For example, application requirements may change temporally (e.g. time of day, day of week, month, season, etc.) or based on events. For example, it may be desirable to adjust the prediction time period where it is known that a network will experience heavy usage (e.g. predicting traffic flows for sporting events).

The first network model may be a traffic flow model. For example, the model may be a mesoscopic, microscopic or macroscopic traffic flow model as will be understood by the those skilled in the art of traffic modelling.

The prediction model may comprise a data fusion module comprising one or more neural networks to combine data from heterogeneous sources in a spatial-temporal graph model. As described above, the network may comprise a plurality of heterogeneous components providing data for use in the methods. The data fusion module may comprise one or more graph networks. The data fusion module may comprise graph convolutional neural networks. By representing the network in the form of a graph network, significant improvements in speed of prediction may be achieved. The data fusion module may be configured to perform a number of operations on the received real-time data. The data fusion module may comprise one or more normalization modules configured to normalize data from one or more of the heterogeneous data sources for fusion. For example, the normalization module may be configured to normalise a time base of the received real-time data (e.g. adjusting for different frequencies and different ways in which the real-time data is aggregated by components within the network and normalising to a consistent time-base (e.g. every minute)). The normalization module may be configured to normalise a spatial base of the received real-time data. For example, the normalization module may be configured to associate each piece of data with a particular component or area of the network (e.g. a road segment). The normalization module may be configured to normalise measurement units and metrics. For example, within a road network, the normalization module may be configured to process the first real-time data to provide data with comparable units such as average speed or traffic flow. It will be appreciated that the normalization module may implement respective normalization operations using any appropriate calculation method or may utilize one or more neural networks as deemed appropriate by a person skilled in the art.

The predictive model may comprise one or more neural networks configured to predict real-time data for future time steps. For example, the predictive model may comprise one or more neural networks configured to receive the real-time data and/or outputs from the data fusion module. It will be appreciated that any suitable machine learning techniques may be used to process the real-time data and/or outputs from the data fusion module to generate predictions for future time steps.

The predictive model may update its models and/or neural networks in response to comparisons of the predicted real-time data for a future time step and the actual real-time data received at the future time step.

The method may further comprise determining a network action based upon the determined state of the network. A network action may be any action that changes a state of the network. For example, in a traffic network, a network action may be closure of a road, opening of a hard-shoulder to regular traffic, adjusting speed limits on road segments, etc. In a communications network, a network action may be re-routing of data traffic between different nodes, offloading data processing from one server to another, etc. In a municipal network, a network action may be sounding an alarm (e.g. in a building), updating signage to direct pedestrians, etc.

The method may comprise causing the determined network action to be performed. For example, the method may comprise providing an indication of the network action to a controller that is configured to cause that network action to be carried out. The method may further comprise carrying out the network action. The data indicative of the state of the network may be a prediction of the future state of the network.

According to an aspect, there is provided a computer-implemented method for determining data indicative of a state of a network, the method comprising: determining a future time step based upon a current time step and a prediction time period; receiving first real-time data associated with the network; inputting the first real-time data to a predictive network model trained to generate predicted real-time data, to generate predicted real-time data for the future time step; executing a first network model based upon the predicted real-time data for the future time step to generate network model output data; and at the future time step, determining data indicative of the state of the network based upon the network model output data.

The method may further comprise at the future time step, receiving second real-time data associated with the network. Determining the data indicative of the state of the network may be further based upon the received second real-time data.

The method may further comprise determining an accuracy score based upon a comparison between the received second real-time data and the predicted real-time data for the future time step. The data indicative of the state of the network may further comprises the accuracy score.

The method may further comprise updating the predictive network model based upon a comparison of the received second real-time data at the future time step and the predicted real-time data for the future time step.

The network model output data and/or the data indicative of the state of the network may comprise a prediction of the state of the network for a second future time step.

The first real-time data may be associated with a first set of components or locations within the network. The data indicative of the state of the network may comprise predicted data for a second set of components or locations, wherein at least one or more of the second set of components or locations is not present in the first set. The predicted data for the second set of components or locations may be generated based upon processing the first real-time data or the network output data using a graph neural network. Processing the first real-time data or the network output data using a graph neural network may comprise aggregating the data associated with the first set of components or location to generate predicted data for the second set of components or locations. The graph neural network may be trained based upon randomly selecting a node to be hidden and predicting the data associated with the selected hidden node.

The predictive network model may be based upon a graph neural network. That is, a graph neural network may be used for temporal predictions and spatial predictions. The same or different graph neural networks may be used for temporal and spatial predictions. The graph neural network may comprise an attention mechanism for aggregating information from neighbouring nodes.

The prediction time period may be based upon a processing time of the first network model. The processing time of the first network model may be greater than the processing time of the predictive network model.

The first real-time data may be based upon data obtained from heterogeneous data sources. The first real-time data may be based upon data obtained from a data source that the first network model is unable to process. The method may further comprise normalizing the first real-time data prior to inputting the first real-time data to the predictive network model. Normalizing the first real-time data may comprise mapping the first real-time data to a common spatio-temporal reference. The first real-time data, the network model output data and/or the data indicative of the state of a network may comprise data indicative of a flow, speed and/or level of congestion of the network.

The first network model may be a traffic flow model. The network may be a transportation network. The first real-time data may be based upon data generated by a traffic sensor and/or data generated by a sensor aboard a vehicle within the transport network.

According to an another aspect, there is provided a computer-implemented method for determining data indicative of a state of a network, comprising: receiving first real-time data associated with the network, the first real-time data associated with a first set of components or locations within the network; inputting the first real-time data to a predictive network model trained to generate predicted real-time data relating a second set of components or locations within the network, wherein at least one or more of the second set of components or locations is not present in the first set; and determining data indicative of the state of the network by executing a first network model based upon the predicted real-time data to generate network model output data.

The method may further comprise processing the first-real time data using the predictive network model to generate the predicted real-time data relating to the second set of components or locations. Processing the first real-time data may comprise aggregating the data associated with the first set of components or location to generate predicted data for the second set of components or locations.

The predictive network model may be based upon a graph neural network. The graph neural network may be trained based upon randomly selecting a node to be hidden and predicting the data associated with the selected hidden node. The graph neural network comprises an attention mechanism for aggregating information from neighbouring nodes.

The first network model may be a traffic flow model. The first real-time data may be based upon data obtained from heterogeneous data sources. The first real-time data may be based upon data obtained from a data source that the first network model is unable to process.

The method may further comprise normalizing the first real-time data prior to inputting the first real-time data to the predictive network model. Normalizing the first real-time data may comprises mapping the first real-time data to a common spatio-temporal reference. The first real-time data, the network model output data and/or the data indicative of the state of a network may comprise data indicative of a flow, speed and/or level of congestion of the network. The network may be a transportation network. The first real-time data may be based upon data generated by a traffic sensor and/or data generated by a sensor aboard a vehicle within the transport network.

According to a further aspect, there is provided a computer apparatus comprising a memory storing processor readable instructions and a processor arranged to read and execute instructions stored in the memory; wherein the processor readable instructions comprise instructions arranged to carry out a method according to any of the above method aspects.

According to another aspect, there is provided a computer readable medium comprising computer readable instructions configured to cause a computer to carry out a method according to any of the above method aspects.

It will be appreciated that features described in the context of one aspect may be combined with features described in the context of another aspect.

### BRIEF DESCRIPTION OF FIGURES

Embodiments of the invention will now be described, by way of example, with reference to the accompanying drawings, in which:

FIG. 1 is a schematic illustration of a system for providing data indicative of a state of a network;

FIG. 2 is a schematic timing diagram of exemplary processing for generating data indicative of a state of a network;

FIG. 3 is a flowchart showing exemplary processing for generating data indicative of a state of a network;

FIG. 4 is a schematic illustration of a computer apparatus suitable for implementing the system of FIG. 1.

### DETAILED DESCRIPTION

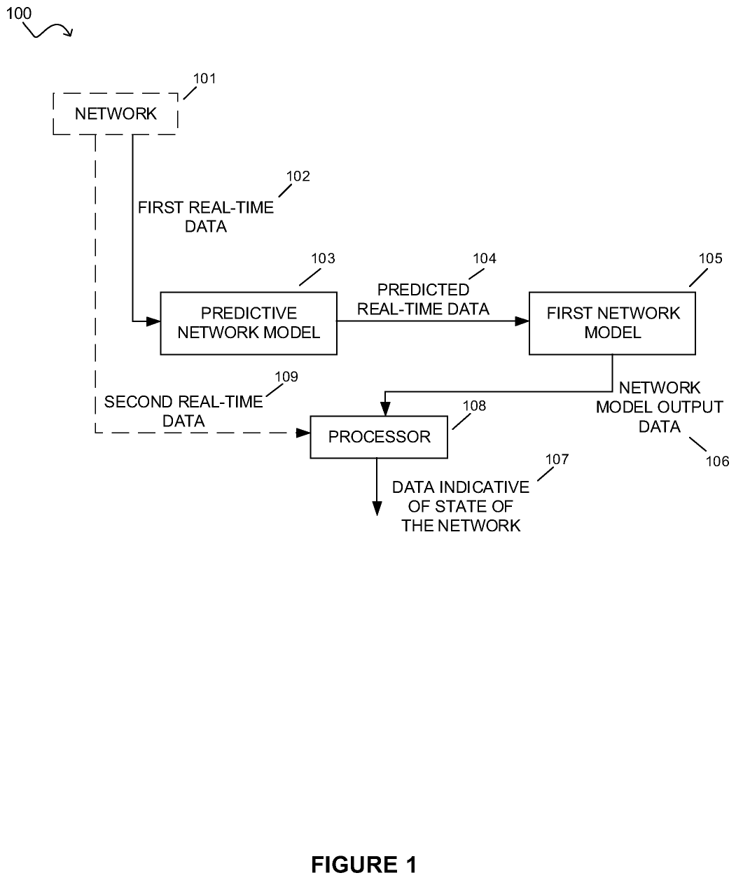

Referring to FIG. 1, there is shown a system 100 which, in general, is configured to determine a state of a network 101. The network 101 may any type of network, for example, a transportation network comprising transport links such as roads and vehicles travelling on those roads, or a computer network comprising data links and entities communicating via such links.

The system 100 is configured to receive first real-time data 102 associated with the network 101. The first real-time data 102 may be generated based upon real-time sensor data associated with the network. For example, in a transportation network, traffic sensors may be present to measure the speed of traffic on a road segment or to count traffic to provide a flow rate. There may also be sensors located on-board public transportation vehicles such as buses, trams and trains. These on-board sensors may report the current location of public transportation vehicles. The sensors may provide data in real-time such that it is possible to determine the current location of a particular bus at any given moment and provide an estimate of the wait time at each stop along its route. In a computer network, the sensors may measure a current load, bandwidth availability, signal strength or any other appropriate measure.

The first real-time data 102 may also be based upon data obtained from heterogeneous data sources. For example, the sensor data provided by traffic sensors may originate from a data source that is different to the data source that provides the sensor data from sensors on-board public transportation vehicles. In this regard, data originating from one data source may have a different format to data originating from another data source. The differences may include both differences in the encoding format of the data as well as differences in how the data is generated. For example, the data may have different sampling rates and thus have different time-bases or the data may be associated with locations having different spatial accuracies. The system 100 may therefore be configured to normalize such data and the first real time-data 102 may be generated based upon the normalized data. Normalization of data is described in further detail below.

The system 100 is further configured to input the first real-time data 102 to a predictive network model 103 to generate predicted real-time data 104 for a future time step. For example, the future time step may be 30 minutes in the future from a current time step associated with the first real-time data 102. The predicted real-time data 104 may comprise predictions for a plurality of time steps in the time period between the current time step and the future time step if required. The future time step is determined based upon the current time step and a prediction time period. Further details with respect to the selection of the prediction time period are described below. In addition to the first real-time data 102 associated with a current time step, the predicted real-time data 104 may also be based upon processing of past real-time data associated with previous time steps.

As noted above, the predictive network model 103 is configured to generate the predicted real-time data 104. The predictive network model 103 may be a machine learning model and may be trained to generate the predicted real-time data 104. For example, the predictive network model 103 may be based upon a graph neural network configured to process a graph representation of the network 101. It will be appreciated that the predictive network model 103 may comprise a plurality of models. For example, each respective model of the plurality of models may be dedicated to providing a prediction of one dimension of the real-time data. For example, the real-time data may comprise data relating to an average speed, traffic flow rate of cars and traffic flow rate of heavy goods vehicles. One model may be dedicated to predicting each of these aspects respectively. Alternatively, a single multi-variate model may be used for predicting all aspects of the real-time data together or combinations of multi-variate and one dimensional models may be employed.

The predictive network model 103 may also be configured to generate predictions relating to one or more components or locations that are not present in the first real-time data 102. That is, the predictive network model 103 may generate data for a “virtual sensor” for a particular location as if a real sensor exists at that location. In this regard, the predicted network model 103 may be configured to generate both spatial and temporal predictions. Further details regarding the predictive network model 103 are described in more detail below.

The system 100 is further configured to execute a first network model 105 based upon the predicted real-time data 104 for the future time step to generate network model output data 106. The first network model 105 may have a processing time that is greater than the processing time of the predictive network model 103. The first network model 105 may therefore be a model that cannot be executed in real-time. The prediction time period and hence the future time step may be based upon the processing time of the first network model 105.

The first network model 105 may be a model that has greater complexity than the predictive network model 103. The first network model 105 may model aspects and events that are not considered by the predictive network model 103 and may provide more accurate or more detailed data regarding the state of the network 101. For example, the first network model 105 may be a simulation model and may simulate traffic flow in the network 101.

Typically, such simulations may be classified as macroscopic, mesoscopic or microscopic. In a microscopic-type simulation, the behaviour of individual entities of the network and the specific properties of network links are modelled. For example, individual vehicles and their braking, acceleration, lane changing behaviour etc. may be specifically simulated along with the number of lanes, road types, speed limits etc. of road links. In a macroscopic-type simulation, individual entities and their behaviour are not simulated and instead network flow may be modelled on an aggregate level using higher-level equations describing speed, density and flow rates. A mesoscopic-type simulation is a hybrid of macroscopic and microscopic-type models. The flow of individual entities may be modelled but specific low-level behaviours are typically not modelled. In one example, the first network model 105 is a mesoscopic traffic flow model of the type typically used for municipal infrastructure planning.

The first network model 105 may provide a prediction of the state of the network further in the future than the predictive network model 103 is accurately capable of and can therefore provide longer-term forecasting. In this regard, the output of the first network model 105 may comprise a prediction of the state of the network 101 for a second future time step and may provide a prediction of how the state of the network 101 may evolve over a particular time period, e.g. in the period between the two time future steps.

Alternatively, or in addition, the first network model 105 may provide additional data relating to other properties of the network 101 as compared to the predicted real-time data 104 or the first network model 105 may refine the predicted real-time data 104 that was input to the first network model 105. Where the first network model 105 is a simulation, the predicted real-time data 104 may be used to initialize the starting conditions for the simulation.

The system 100 is configured to determine data indicative of the state of the network 107 based upon the first network model output data 106 at the future time step. The data indicative of the state of the network 107 may relate to a particular property of the network. For example, the data may comprise an indication of the congestion level of particular parts of the network 101. The indication may be a congestion index or rating. The data may further comprise an alert where the congestion level is above a particular threshold which may be an indicator that a particular adverse event is developing. The system 100 may also determine a network action to be performed based upon the data indicative of the state of the network 107. The system 100 may automatically carry out the action or prompt an operator that an action may be required. Actions may include re-routing traffic along a different path, speed limits may be adjusted, a traffic lane may be opened or closed on a road, and maintenance work may be scheduled amongst other suitable actions. In addition, on a computer network, additional servers and/or other network devices may be brought online and/or faulty devices may be taken offline.

The data may also comprise data for components or locations that are not present in the first real-time data 102. As discussed above, such data may be generated by the predictive network model 103. Alternatively, or in addition, the system 100 may comprise a second predictive model which may be configured to generate the data for these additional components or locations based upon processing of the first network model output data 106 and/or the predicted real-time data 104.

The data indicative of the state of the network 107 may also comprise data for a particular period of time, for example, between the future time step and a second future time step, thereby providing a prediction of how the state of the network may change over time in the future. Thus, the data indicative of the state of the network 107 may provide spatial and temporal prediction data further into the future as well as data for the present time.

The system 100 may be further configured to receive second real-time data 109 at the future time step and the data indicative of the state of the network 107 may be further based upon the received second real-time data 109. For example, the system 100 may be configured to determine an accuracy score based upon a comparison between the received second real-time data 109 and the predicted real-time data 104 for the future time step. Thus, if the predicted real-time data 104 for a particular future time step is accurate as compared to the actual real-time data (the second real-time data 109) for that time step, it can be determined that the first network model 105 has been executed on the basis of accurate predictions. Therefore the first network model output 106 and the data indicative of the state of the network 107 can be trusted with a good degree of confidence. It will be appreciated that the second real-time data 109 may be obtained from the same data source(s) as the first real-time data 102.

The accuracy score may be based upon a normalized root mean-squared error. The accuracy score may also take account of factors such as the time of day and may be based upon a historical accuracy model.

The first network model 105 itself may also be configured to generate a confidence score associated with its output. The determination of the data indicative of the state of the network 107 may be further based upon any such confidence/accuracy scores and/or any other suitable accuracy/error measurements. The data indicative of the state of the network 107 may comprise the confidence/accuracy scores. An operator may inspect the confidence/accuracy scores to determine whether action should be taken on the basis of the generated data.

The predictive network model 103 may also be updated based upon a comparison of the received second real-time data 109 at the future time step and the predicted real-time data 104 for the future time step. The predictive network model 103 may be updated after each comparison or may be updated in a batch mode, that is, based upon comparison data collected after a certain period of time has elapsed or a certain amount of comparison data has been collected. For example, the predictive network model 103 may be updated once every night based upon the comparison data collected through the day. The network may be dynamic, in particular, transportation networks may change due to road closures from scheduled maintenance or accidents, speed limits may change temporarily, public transportation timetables and routes may be updated amongst other examples. Updating the predictive network model 103 ensures that changes in the network may be reflected in the predicted data generated by the predictive network model 103. In this regard, the predictive network model 103 may be considered to be an online or continuous learning system.

The system 100 may comprise one or more processors 108 configured to perform the determination of the data indicative of the state of the network 107. It will be appreciated that the execution of the first network model 105 and the generation of the predicted real-time data 104 using the predictive network model 103 may also be carried out by the processor(s) 108.

It will be further appreciated that multiple instances of the first network model 105 may be executed concurrently on the basis of different sets of real-time data received at different time steps. In this way, the system 100 may be a distributed system with each processing node running a different instance of the first network model 105 (and/or any other model described above).

In some prior art methods, the first network model 105 may be executed on the basis of the first real-time data 102 which by the time the first network model 105 finishes executing, the output of the first network model 105 may already be out of date and inaccurate. As such, more complex models tend not to be used for real-time evaluation and decision making even though these models could provide insightful data.

By executing the first network model 105 on the basis of predicted real-time data 104 for a particular future time step, the output of the first network model 105 may be more relevant to the particular future time step than if the first network model 105 was executed on the basis of the first real-time data 102 which could be severely out of date by the time the first network model 105 completes processing.

As such, the present system 100 enables these slower and more complex models to be incorporated into systems that provide real-time analysis of networks. Thus, for a particular time step, the state of the network can be evaluated in real-time on the basis of both real-time data associated with the network received at the particular time step and output data from the first network model that is also likely to be highly relevant at the particular time step.

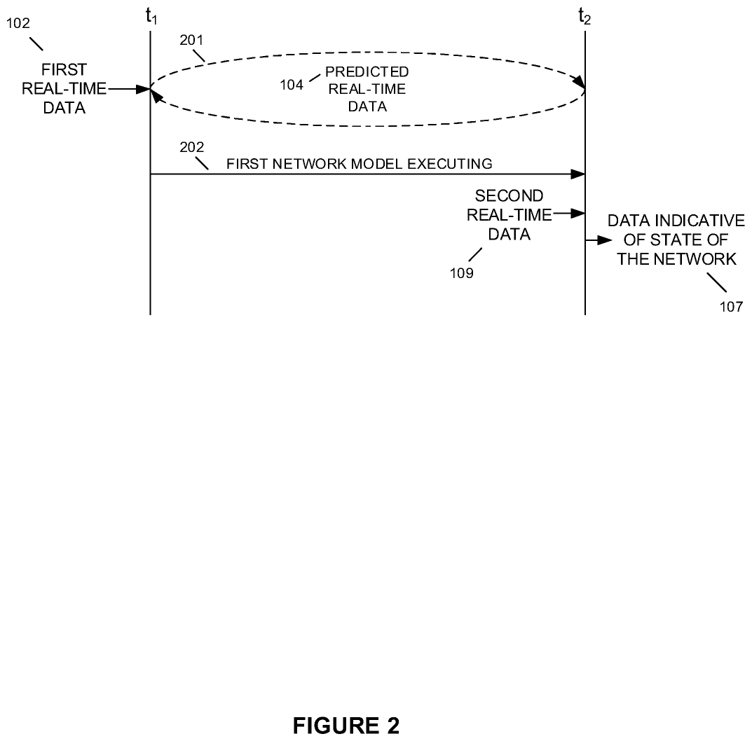

FIG. 2 provides a further exemplary illustration of the timings described above. Where the elements of FIG. 2 are the same as the elements of FIG. 1, these have the same reference numerals.

It is desired that at time t₂, data indicative of the state of the network 107 is provided. Based upon the processing time of the first network model 105, it is determined that the first network model should begin execution at time t₁ in order to provide output for time t₂.

At time t₁, the first real-time data 102 is received. Also at time t₁, the predictive network model 103 is used to generate the predicted real-time data 104 for time t₂ as shown by the dashed arrows 201. As the predictive network model 103 can execute in substantially real-time, the predicted real-time data 104 can be considered to be obtained at time t₁. The first network model 105 can then begin execution on the basis of the generated predicted real-time data 104 for time t₂.

The first network model 105 completes execution at time t₂ as shown by the solid arrow 202. Also at time t₂, second real-time data 109 may be received. The data indicative of the state of the network 107 may then be determined on the basis of the first network model output data 106 and optionally also on the basis of the second real-time data 109 at time t₂. In this way, the first network model 105 can generate output that is relevant for time t₂ which can be used for real-time analysis of the state of the network 101 at time t₂.

In addition to the above described temporal advantages, the use of the predictive network model 103 can also provide additional advantages. For example, the first network model 105 may be a model that cannot be easily re-trained or adapted to new data sources. The predictive network model 103 can be used to process data from sources that the first network model 105 is unable to by generating predicted real-time data 104 in a form that is usable by the first network model 105. Thus, the execution of the first network model 105 can take account of data that would have been unusable by the first network model 105. In this regard, the predicted real-time data 104 and the received first real-time data 102 may be different. The predicted real-time data 104 may comprise predicted values for a subset of the first real-time data 102 or may be entirely different to the first real-time data 102.

The first real-time data 102 may be based upon data obtained from heterogeneous data sources. For example, as discussed above, one data source may provide data obtained from traffic sensors that provide an average speed and/or traffic count. Another data source may provide data obtained from sensors on-board public transportation vehicles. The data obtained from these on-board sensors may be a GPS trace showing a location history of a particular vehicle whilst a traffic sensor may be a measurement at one location. The data from the different data sources may be normalized prior to processing by the different models of the system 100. For example, a GPS trace may be converted to a speed associated with different road segments with a particular directionality. Traffic sensor data may be mapped from a point location to a road segment with directionality. Thus, in this regard, the data may be mapped to a common geographical/spatial reference and converted to common measurements with the same numerical units. As described above, the sampling rates of the data may also require normalization to a common temporal basis, for example, by aggregating the data into common timeframes. Thus, a person skilled in the art may choose an appropriate spatio-temporal reference and map the received data to the common spatio-temporal reference as deemed appropriate. It will be appreciated that any further real-time data received may also undergo normalization.

As discussed above, any of the predictive models may be implemented based upon a graph neural network. In general, a graph neural network performs processing on an input graph to provide some output data relating to the graph. A graph comprises a set of nodes and edges. The nodes represent particular entities of the network and the edges represent the links between the entities. A node may comprise a feature vector representing the data and any properties associated with the node, for example, a sensor data measurement, a geographical location or a type of entity. The graph neural network typically comprises a learnable aggregation function implemented by one or more neural network layers to produce a latent representation of a node that aggregates information from other nodes in the graph according to the graph structure. The graph neural network is capable of learning the underlying relationships between nodes of the graph. The latent representations of the nodes may be further processed by other neural network layers to provide a final output such as predicted data for the node at a future time step. It is also possible to introduce new nodes into the graph and obtain predicted data for these new nodes to provide spatial data prediction as discussed above.

The particular choice of aggregation function and graph neural network structure may be dependent on the type of prediction required, the properties of the network and the amount of prior knowledge of the network available. For example, in a transportation network, nodes may represent locations where sensor data is available. However, given that road networks typically provide many routes via which different locations can be accessed, there may be difficulty in determining which nodes should be considered to be adjacent to each other. In such cases, each node may be considered to be connected to every other node and the graph neural network learns how each node influences another for aggregating information. By comparison, computer networks typically have a more established structure that is easier to represent as adjacent nodes in a graph.

For temporal prediction, a suitable graph neural network may be implemented based upon the Graph WaveNet technique. This technique does not require adjacency information but adjacency information can be made use of. Details of the Graph WaveNet technique can be found in Wu et al., Graph WaveNet for Deep Spatial-Temporal Graph Modeling, arXiv: 1906.00121, 31 May 2019, available at https://arxiv.org/abs/1906.00121 which is hereby incorporated by reference in its entirety. In brief however, a graph neural network based upon a Graph WaveNet technique may be configured to process a sequence of data associated with a graph comprising S previous time steps of data to generate a prediction of the data for next T time steps. For example, a sequence of 12 previous time steps may be used as input to provide a prediction for the next 12 time steps. Each time step may represent 5 minutes for example. It will however be appreciated that any number time steps may be used for input and output and each time step may represent any time scale as deemed appropriate by a person skilled in the art.

The Graph WaveNet technique uses a learnable self-adaptive adjacency matrix parameterized by a learnable first embedding for source nodes and a learnable second embedding for target nodes. The adjacency between nodes can be computed by multiplying respective first embeddings of each node with respective second embeddings of each node followed by a non-linearity and applying a softmax function to normalize the weightings obtained. This adjacency matrix can capture the hidden spatial relationships between nodes and can be used in aggregating information from a neighbourhood of a node.

In this regard, the graph neural network may comprise a graph convolution layer which produces a latent representation of a node based upon aggregating the data from every other node weighted by a learnable weight matrix and further adjusted by the learnable adjacency matrix. This aggregation operation may be repeated for a number of iterations which enables data from more distant nodes to be propagated through the graph and therefore provides spatial data aggregation.

The graph neural network may further comprise a temporal convolutional layer which aggregates information from different time steps using dilated convolution together with a gating mechanism. The graph convolutional layer and temporal convolution layer may be combined to provide a spatio-temporal layer. For example, temporal convolution may be performed first on the input to the spatio-temporal layer and the output of temporal convolutional layer may be provided as input to a graph convolutional layer. The spatio-temporal layers may be stacked to allow for spatial processing on different time-scales. A final set of output layers may be used to generate the predicted data.

In the Graph WaveNet technique, the graph neural network may be trained using standard stochastic gradient descent methods to minimize a loss function with respect to the learnable parameters of the graph neural network. The loss function may be based upon the mean absolute error between the predicted data for each time step and target data obtained from a training dataset of graphs. It will be appreciated that the loss function may be based upon other error metrics as deemed suitable by a person skilled in the art.

Where adjacency information is available, another suitable graph neural network technique may be based upon a Diffusion Convolutional Recurrent Neural Network technique. Details of this technique can be found in Li et al., Diffusion Convolutional Recurrent Neural Network: Data-Driven Traffic Forecasting, arXiv: 1707.01926, 22 Feb. 2018, available at https://arxiv.org/abs/1707.01926 which is hereby incorporated by reference in its entirety. In brief, in this technique, the aggregation of information across nodes in the graph is based upon a diffusion process. A number of bidirectional random walks on the graph are performed to determine a probability distribution of the likelihood of diffusion from each node of the graph using the adjacency information. The diffusion probability distribution can be used to weight a convolution operation with learnable filters for aggregating information from neighbouring nodes. Temporal dynamics may be captured using a recurrent neural network. The matrix multiplications of the recurrent neural network can be replaced with the diffusion convolution operation to provide a diffusion convolutional recurrent layer. These layers may be stacked and arranged in an encoder/decoder architecture. The input of the encoder may be the input sequence of past data and the output of the decoder may be the predicted sequence of data. Again, the graph neural network can be trained using standard stochastic gradient descent methods to minimize a loss function with respect to the learnable parameters of the graph neural network. The loss function may be based upon an error metric between the predicted data and target data obtained from a training dataset of graphs.

For spatial and temporal prediction without the requirement of adjacency information, a suitable graph neural network technique is the Graph Attention Network. Details of this technique can be found in Veličković et al., Graph Attention Networks, arXiv: 1710.10903, 4 Feb. 2018, available at https://arxiv.org/abs/1710.10903 which is hereby incorporated by reference in its entirety. In brief, a Graph Attention Network comprises one or more stacked graph attentional layers and each graph attention layer comprises one or more parallel attention heads. In each attention head, the node feature vectors are multiplied by a learnable weight matrix and may then be further processed by one or more non-linear neural network layers. Attention weights indicating the importance of one node with respect to another can be computed by applying a softmax function to the output of these neural network layers for each node. These attention weights can then be used to weight the aggregation of information from each node to every other node to provide part of the latent representation of the each node. The output of each parallel attention head may be aggregated to form the latent representation of the node for that attentional layer.

The final output the graph neural network may be a prediction of the data for each node. For example, the prediction may be a prediction of the data at a future time step and hence the network can provide temporal prediction. For spatial prediction, new nodes with appropriate feature information may be added to the graph, such as geographical location information. The graph neural network can generate predicted data for that new node based upon the data from existing nodes. The network can be trained for spatial prediction by randomly selecting one or more nodes to have their data hidden and having the network predict the hidden data whilst maintaining the values of the other visible nodes. A loss function can be constructed based upon a suitable error metric and standard stochastic gradient descent methods to minimize the loss function with respect to the learnable parameters of the graph neural network can be used for training.

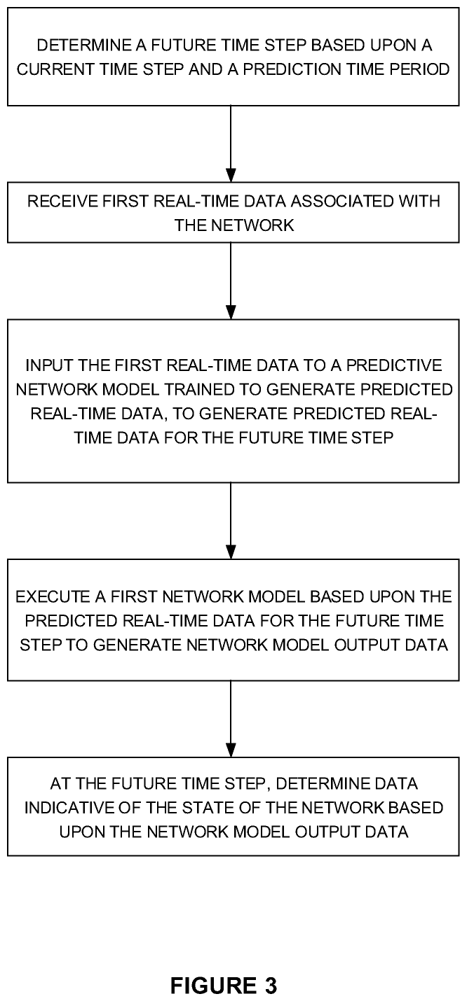

Referring now to FIG. 3, there is shown exemplary processing for determining data indicative of a state a network. It will be appreciated that the processing may be carried out by the system 100 of FIG. 1. At step 301, a future time step based upon a current time step and a prediction time period is determined. As discussed above, the future time step may be based a processing time of a network model and a desired time at which the analysis of the network is to be carried out.

At step 302, first real-time data associated with the network is received. For example, the first real-time data may comprise data obtained from sensors on the network as discussed above. The first real-time data may also be normalized to a common spatio-temporal reference if the data is obtained from a plurality of different data sources as noted above.

At step 303, the first real-time data is input to a predictive network model trained to generate predicted real-time data in order to generate predicted real-time data for the future time step. For example, the predictive network model may be based upon a graph neural network as discussed above.

At step 304, a first network model is executed based upon the predicted real-time data for the future time step to generate network model output data. The first network model may have a processing time that is greater than the processing time of the predictive network model and is typically of greater complexity than the predictive network model. The network model output data may comprise a refinement of the predicted real-time data, additional data relating to other properties of the network and/or additional predicted data for a second future time step as discussed above.

At step 305, at the future time step, data indicative of the state of the network is determined based upon the network model output data. For example, the data indicative of the state of the network may relate to a particular property of the network such as an indication of the congestion level of particular parts of the network. The data may also comprise data for a particular time period and provides a prediction of how the state of the network may change over time in the future, as discussed above.

In an alternative method, data indicative of a state of a network may be determined through spatial prediction alone. For example, first real-time data associated with the network may be received. The first real-time data may be associated with a first set of components or locations within the network and the first real-time data may be input to a predictive network model trained to generate predicted real-time data relating a second set of components or locations within the network, wherein at least one or more of the second set of components or locations is not present in the first set. Data indicative of the state of the network may be determined by executing a first network model based upon the predicted real-time data to generate network model output data.

In this case, the predictive network model may be implemented using a graph neural network as described above and the first network model may also be implemented as described above.

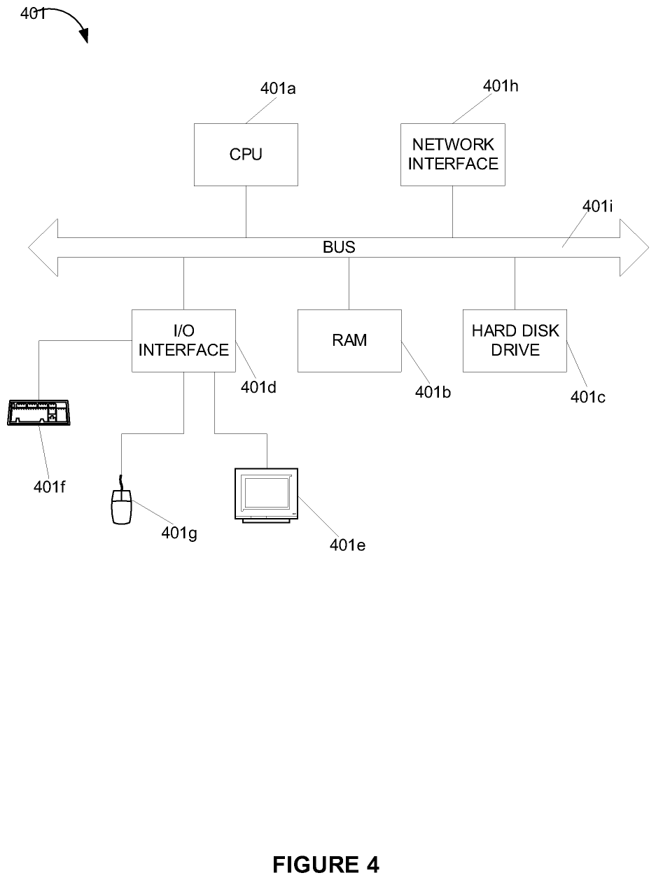

Referring now to FIG. 4, there is shown a computer apparatus 401 suitable implementing the system 100 of FIG. 1. It can be seen that the computer 401 comprises a CPU 401a which is configured to read and execute instructions stored in a volatile memory 401b which takes the form of a random access memory. The volatile memory 401b stores instructions for execution by the CPU 401a and data used by those instructions. For example, in use, the first real-time data 102 may be received and stored in the memory 401b for processing and the predicted real-time data 104 may be generated and stored in the memory 401b for further processing.

The computer 401 further comprises non-volatile storage in the form of a hard disc drive 401c. For example, the models of the system 100 may be stored and retrieved from the hard disc drive 401c. The computer 401 further comprises an I/O interface 401d to which are connected peripheral devices used in connection with the computer 401. More particularly, a display 401e is configured so as to display output from the computer 401. The display 401e may, for example, display the data indicative of the state of the network 107. Input devices are also connected to the I/O interface 401d. Such input devices include a keyboard 401f and a mouse 401g which allow interaction with the computer 401. Other input devices may also include gesture-based input devices. A network interface 401h allows the computer 401 to be connected to an appropriate computer network so as to receive and transmit data from and to other computing devices. The CPU 401a, volatile memory 401b, hard disc drive 401c, I/O interface 401d, and network interface 401h, are connected together by a bus 401i.

It will be appreciated that the computer apparatus 401 may be a server. A plurality of servers (e.g. a distributed system) may also be used to implement the system 100 where appropriate.

Although specific embodiments of the invention have been described above, it will be appreciated that various modifications can be made to the described embodiments without departing from the spirit and scope of the present invention. That is, the described embodiments are to be considered in all respects exemplary and non-limiting. In particular, where a particular form has been described for particular processing, it will be appreciated that such processing may be carried out in any suitable form arranged to provide suitable output data.

1. A computer-implemented method for determining data indicative of a state of a network, the method comprising:
determining a future time step based upon a current time step and a prediction time period;
receiving first real-time data associated with the network;
inputting the first real-time data to a predictive network model trained to generate predicted real-time data, to generate predicted real-time data for the future time step;
executing a first network model based upon the predicted real-time data for the future time step to generate network model output data; and
at the future time step, determining data indicative of the state of the network based upon the network model output data.

2. A method according to claim 1, further comprising:
at the future time step, receiving second real-time data associated with the network; and
wherein determining the data indicative of the state of the network is further based upon the received second real-time data.

3. A method according to claim 2, further comprising:
determining an accuracy score based upon a comparison between the received second real-time data and the predicted real-time data for the future time step; and wherein the data indicative of the state of the network further comprises the accuracy score.

4. A method according to claim 2, further comprising updating the predictive network model based upon a comparison of the received second real-time data at the future time step and the predicted real-time data for the future time step.

5. A method according to claim 1, wherein the network model output data and/or the data indicative of the state of the network comprises a prediction of the state of the network for a second future time step.

6. A method according to claim 1,
wherein the first real-time data is associated with a first set of components or locations within the network; and
wherein the data indicative of the state of the network comprises predicted data for a second set of components or locations, wherein at least one or more of the second set of components or locations is not present in the first set.

7. A method according to claim 6, wherein the predicted data for the second set of components or locations is generated based upon processing the first real-time data or the network output data using a graph neural network.

8. A method according to claim 7, wherein processing the first real-time data or the network output data using a graph neural network comprises aggregating the data associated with the first set of components or locations to generate predicted data for the second set of components or locations, and
wherein the graph neural network is trained based upon randomly selecting a node to be hidden and predicting the data associated with the selected hidden node.

9. (canceled)

10. A method according to claim 1, wherein the predictive network model is based upon a graph neural network.

11. A method according to claim 7, wherein the graph neural network comprises an attention mechanism for aggregating information from neighbouring nodes.

12. A method according to claim 1, wherein the prediction time period is based upon a processing time of the first network model.

13. A method according to claim 1, wherein the processing time of the first network model is greater than the processing time of the predictive network model.

14. A method according to claim 1, wherein the first network model is a traffic flow model.

15. A method according claim 1, wherein the first real-time data is based upon data obtained from heterogeneous data sources.

16. A method according to claim 1, wherein the first real-time data is based upon data obtained from a data source that the first network model is unable to process.

17. A method according to claim 1, further comprising:
normalizing the first real-time data prior to inputting the first real-time data to the predictive network model,
wherein normalizing the first real-time data comprises mapping the first real-time data to a common spatio-temporal reference.

18. (canceled)

19. A method according to claim 1, where the first real-time data, the network model output data and/or the data indicative of the state of a network comprises data indicative of a flow, speed and/or level of congestion of the network.

20. A method according to claim 1, wherein the network is a transportation network, and
wherein the first real-time data is based upon data generated by a traffic sensor and/or data generated by a sensor aboard a vehicle within the transport network.

21. (canceled)

22. A computer apparatus comprising:
a memory storing processor readable instructions; and
a processor arranged to read and execute instructions stored in the memory;
wherein the processor readable instructions comprise instructions arranged to cause the computer to carry out a method according to claim 1.

23. A computer readable medium comprising computer readable instructions configured to cause a computer to carry out a method according to claim 1.
